(19) United States
(12) Patent Application Publication
(10) Pub. No.: US 2020/0074532 A1
(43) Pub. Date: Mar. 5, 2020

(54) SIMPLIFIED ONLINE ORDERING PLATFORM

(71) Applicants: Richard Rotbard, New City, NY (US); Scott Saltiel, New City, NY (US); Nishakar Kamboj, New York, NY (US)

(72) Inventors: Richard Rotbard, New City, NY (US); Scott Saltiel, New City, NY (US); Nishakar Kamboj, New York, NY (US)

(21) Appl. No.: 16/560,602

(22) Filed: Sep. 4, 2019

Related U.S. Application Data
(60) Provisional application No. 62/726,492, filed on Sep. 4, 2018.

(51) Int. Cl. G06Q 30/06; G06Q 50/12

(52) U.S. Cl. CPC G06Q 30/0637; G06Q 50/12; G06Q 30/0641

(57) ABSTRACT

A method of placing orders by a consumer online for food items to a desired business for delivery or pick-up. A messaging server receives an order message from the consumer identifying the consumer, the desired business, and one or more food items for delivery to or pick-up by the consumer. The messaging server then sends a response to the order message, requesting the consumer to confirm the order message as received by the messaging server. Upon receiving a confirmation of the order message from the consumer, the messaging server sends the order message to the desired business where the order message is displayed on a device at the location of the business.

### CROSS REFERENCE TO RELATED APPLICATION

This application claims priority under 35 U.S.C. § 119(e) of U.S. Provisional Patent Application No. 62/726,492 filed Sep. 4, 2018, the entire contents of which are incorporated herein by reference.

### BACKGROUND OF THE INVENTION

### Field of the Invention

The present invention relates to a method and system for placing an order with a restaurant or other prepared food business from a remote location online.

### Discussion of the Known Art

Food ordering systems are currently available to consumers, including systems that operate online. The known ordering systems require, however, either an integration to a specific point of sale (POS) system used by the provider, or the entry of many keystrokes by the consumer to identify specific menu items that he or she wishes to order, as well as the initial entry of the menu items into the system by the provider. The known systems therefore require a relatively cumbersome interface simply to enable the consumer to ring up a food order.

U.S. Pat. No. 8,954,349 (Feb. 10, 2015) relates to a system that uses a text messaging protocol to allow a connected user to obtain goods or services via a network controller. Also, U.S. Pub. No. 2014/0149234 (May 29, 2014) discloses a method by which restaurant customers can, inter alia, place food orders by the use of a POS device provided at the restaurant.

Notwithstanding the known art, there exists a need for an online food ordering system that simplifies the ordering experience for both consumers and restaurants, by allowing consumers to use standard vernacular input to place orders remotely to participating restaurants or other food establishments for delivery or pickup. There is also a need for an ordering system that does not require restaurant employees to take time to manage live incoming telephone calls for food orders to go or for delivery.

### SUMMARY OF THE INVENTION

According to the invention, a method of placing orders by a consumer online for food items to a desired business for delivery or pick-up, includes receiving, by a messaging server, an order message from the consumer identifying the consumer, the desired business, and one or more food items for delivery to or pick-up by the consumer. The messaging server sends a response to the order message, requesting the consumer to confirm the order message as received by the messaging server. Upon receiving a confirmation of the order message from the consumer, the messaging server sends the order message to the desired business where the message is displayed on a device at the business.

For a better understanding of the invention, reference is made to the following description taken in conjunction with the accompanying drawing and the appended claims.

### BRIEF DESCRIPTION OF THE DRAWING FIGURES

In the drawing:

FIGS. 1 and 2 together illustrate the overall configuration of the inventive online food ordering platform.

### DETAILED DESCRIPTION OF THE INVENTION

As used herein, the terms restaurant, store, and business are used interchangeably to connote a provider or vendor of food items that will accept orders placed remotely by consumers for either delivery or pickup. The terms user and consumer are also used interchangeably to mean a person who wishes to order one or more food items from a desired restaurant, store, or business.

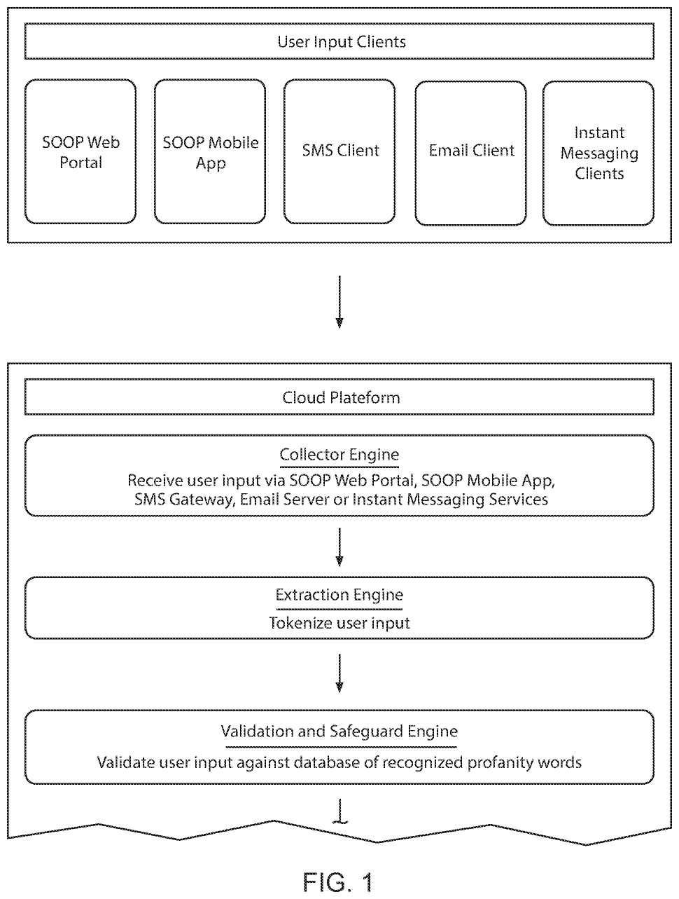

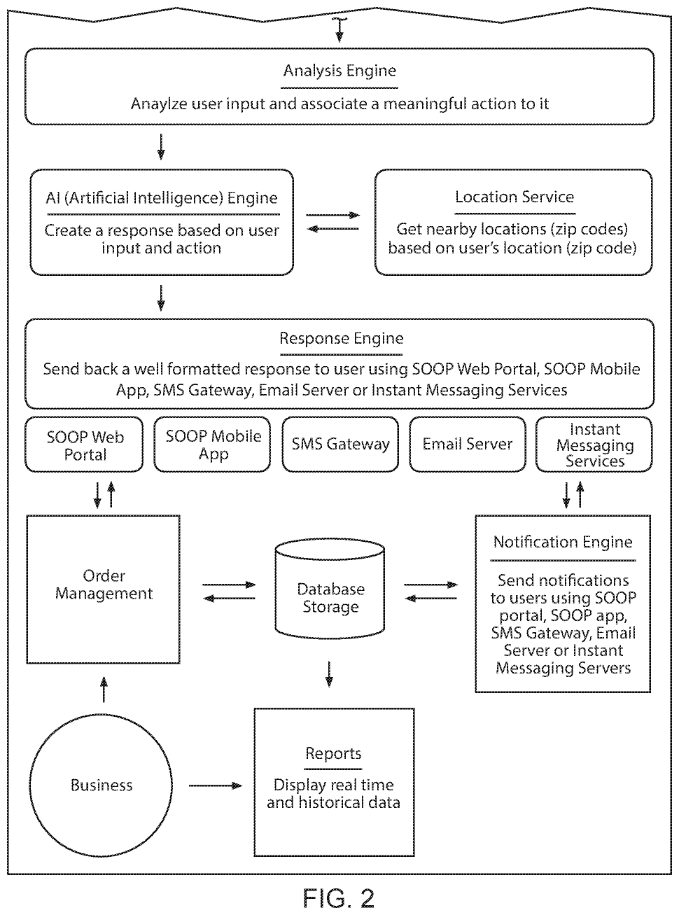

The inventive simplified online ordering platform (hereafter “SOOP”) can provide a user with services that include, but are not limited to, text messaging, email, Facebook messenger, WhatsApp, a SOOP app (for android/iOS), and Artificial Intelligence Engines (e.g., Google Home, Apple's Siri, IBM's Watson, and Amazon's Alexa service), in order to enable the user to type or dictate a food order to a desired restaurant or business via free text or speech. In the embodiment shown in FIGS. 1 and 2, the user's order is displayed at the restaurant location as an on-screen notification on a multi-platform interface device such as, e.g., a tablet.

The typed or dictated order displays in a list format in the same manner it is submitted by the user, along with important details (user name, telephone number, and address for directions). The restaurant operator is then able to respond to each order by accepting or rejecting it, and to inform the user of the total cost. Once the user receives the response, SOOP can initiate a payment request to transfer funds between the parties in order to pay for the order.

SOOP eliminates the need for restaurant owners or employees to receive and respond in real time to orders from remote users, and affords them more time to handle orders whether placed by phone or online by directing each order into a queue and displaying the order on a tablet or other device maintained near the restaurant register. The restaurant no longer needs to man a telephone to handle one live order at a time, and the queue of orders can be accessed and processed whenever the restaurant owner's time permits. This results in a more efficient method of handling orders that might otherwise need to be handled live over the phone.

At the same time, SOOP provides an extremely convenient method of placing and paying for orders by users without requiring them to look up, e.g., restaurant or store telephone numbers, web sites, or Facebook pages. That is, the user merely types out or dictates what they want, and the store receives the order exactly as submitted by the user. This is a time saver for consumers who do not wish to look up contact information for a particular business and/or who generally know what they want to order.

### SOOP Interfaces (See FIGS. 1 and 2)

As presently disclosed, SOOP has three interfaces, viz., two tablet/smartphone app based interfaces, and one web portal. The web portal is for both the user or consumer, and the store or business owner. The consumer version duplicates the functionality of the app whereby a consumer can set up their own account, connect to the SOOP service, and utilize all of its functionality available for that user. The business web portal is a service that allows the business to edit its account and access SOOP features. One app serves as the business's standalone order kiosk, and it can reside on a tablet conveniently located for order taking at the business. The second app resides on a consumer's smartphone or tablet for the purpose of setting up their account, and for administering their orders and order history. SOOP may also run as a web service if users do not wish to use an app, in which case SOOP can be web browser based.

### Business Web Portal:

This is a web interface by which a store or business can connect to the SOOP service. Once the business is registered, it becomes part of a list of businesses available to consumers from which they can place orders. Upon completing a set up, the business app allows the business to connect to SOOP to retrieve orders placed by consumers.

Key information, such as business name, business type (for example, category of business—pizza, Chinese, Italian, etc.), address, contact information, and business hours are stored. Additionally, a business can upload or add a menu on their web portal to send to users who request the menu. The business can also add menu items in database format and indicate key words for each menu item, for the purpose of word matching when a consumer indicates the menu items on their orders. Delivery personnel names and mobile phone numbers can be entered as well for delivery purposes as discussed later.

If a business decides to enter their menu into their web portal interface, then, when a consumer submits an order which is based generally on free text or speech converted to text, the SOOP service tries to match key words from each item ordered to the nearest matching menu item. If no match is found, it simply displays the line as free text on the business's order app. If a match exists, SOOP corrects the entry to the matching menu item. After the SOOP engine receives the order and before submitting it to the business app, the SOOP engine generates an automated response to the consumer to confirm his or her order. If any lines were matched, the corrected line item is displayed. If not, it will indicate that the item has not been matched to a specific store menu item, and is being sent as free text. If present, prices are also displayed. The business operator can also respond with a total price when the business accepts an order. If the business chooses to reject an order, or any line of the order, it can also indicate a reason for the rejection.

A confirmation is sent back to the consumer in the same manner the consumer communicated the original message. For example, if the consumer sent an SMS to SOOP, the responses are sent by SMS as well.

### API:

An API will allow a third-party system to push their menu data to the menu database in the business's SOOP account. Additionally, the API can also allow for the push of order information from SOOP to the third-party platform. This allows SOOP to integrate with existing point-of-sale (POS) systems and/or back-end POS portals. This integration is configured to streamline the process of maintaining menu items as well as synchronizing sales data to an existing POS system.

### Business App:

The business app includes an iOS and/or Android interface that connects to the SOOP engine. Once a business signs in to the service, the connection remains alive until the business logs out. The business app has a login screen and offers the same web portal features based on the business account that is logging in. For an order operator at the business, the interface displays boxes with line item data in each box, wherein each box represents a separate consumer order. The box contains, e.g., a telephone number as an identifier of the consumer, as well as their name and address if it is a delivery order. This information is taken from the consumer's account information as entered by the consumer in his or her user preferences.

Additionally, the box displays whether the item is for pick up or for delivery. If a delivery item, the business app user can press the order and choose to view delivery instructions (based, e.g., on GPS data from the business's location to the consumer's address from their account). The delivery information is printable or can be sent to a delivery person's mobile phone as a text message, or directly into their navigation app (Waze, Google/Apple Map apps). In addition, the box contains each line item that is being ordered. As new orders are submitted, a queue of orders is displayed one next to the other in a first come first serve order. If the screen fills, all the newest orders may be retrieved by scrolling or swiping a finger depending on the tablet's multi-touch capabilities. The oldest orders should preferably default to display first. At this point, the business owner or employee can key in the order into their existing POS system, or write up the order as they normally would. Once, the order is entered, the box is pressed and a choice, Accept or Decline, is displayed. If the business chooses Accept, then the operator has the ability to send either a default or a customized Accept message along with the price of the order.

The order is then archived into an order history for later retrieval if necessary, and removed from the screen. In the preferences, there is a formula to determine how long the order will take to be ready for pick up or delivery. For example, if there is a queue of orders and it takes 10 minutes per order, the formula can calculate the time it will take to get to the third order in the queue. This information can be sent as part of the Accept message back to the consumer. If the order is declined, the owner or employee can type a reason and the consumer will be alerted with the message. The consumer will be able to make edits as necessary or cancel the order once they are notified. Their edits can be done either via the consumer app or via the same method as originally entered with a control code to access the existing order.

### Consumer App/Web Portal:

The consumer app and the web portal may have the same functionality and will allow a consumer to create an account with SOOP. The consumer account will include, e.g., their contact information such as Name, Address, telephone number, default and additional addresses (for delivery to addresses beyond the default), and any business preferences (e.g., a favorite business they can label for quick access). From here, they can connect the app to, e.g., their Facebook account and add the SOOP service as a skill using the Amazon Alexa service as well as Google Home and Siri. For example, if a business is set as one of a consumer's favorite businesses, the consumer will not have to indicate any location information when placing an order. They can simply state the label that they chose for the business, and SOOP will default to that business/location when placing an order. The app may have a free text area that allows the user to type in information. Certain key words can be used to indicate certain actions with the aid of a SOOP artificial intelligence (AI) engine. For example, the word “From” will indicate to which business the order will be submitted. If the business is set as a favorite in the preferences, then there is no need to specify any other important information such as location.

While the user is sending free text messages to SOOP, the SOOP engine reads each line of the text and attempts to match the text to known commands or variables. SOOP looks for business name, items, and whether the order is for pickup or delivery. Additionally, the SOOP AI engine can provide a host of other commands that SOOP will recognize, such as Menu, Guide Me, and Businesses Nearby. These features are discussed later.

### Methods of Communication with SOOP (See FIGS. 1 and 2)

### Text Message/Email/WhatsApp/Facebook Messenger:

SOOP provides one contact number and email address for consumer users to add to their contacts. For text messaging (SMS), SOOP provides a text enabled telephone number or shortcode to which a user can send a message. For emails, SOOP provides an email address. Both the SMS and the em ail contact info are available to all consumers to use when adding SOOP as a contact, and SOOP will receive all order requests. There is also one contact for SOOP for WhatsAPP, as well as Facebook Messenger.

Example of Message from Consumer:
To: SOOP (Contact Number or Email address)

### Joe's Pizza

1 eggplant parm hero
1 large pie with pepperoni
1 liter Coca-Cola

### Pickup

Note: If Joe's Pizza in New City, N.Y. is set as a favorite, and the user chooses to label it “Joe's” in their user preferences, then the user will not have to indicate the formal name of the business.

Example of a Response from SOOP:
Hi Richard, let's see if I have this right. You are ordering the following from Joe's Pizza at 120 Main Street, New City, N.Y. 10956:
1 eggplant Parmesan hero $7.99
1 large pizza pie $16.99

add Pepperoni $1.50

1 liter Coca-Cola $1.99

### For Pickup

Is this right? (Yes or No)

Note: If SOOP does not find a match to an existing item, it will not display the price and will not display tax and total. Instead of a price showing next to the line item, it will display a “not found” message to indicate that there was no match. If prices are not available or the business has not entered its menu items to the SOOP menu database, the business operator can still enter the amount of the order in their response.

SOOP also determines the correct business based on the ZIP code of the user's address. If a delivery order, the consumer can specify a delivery address as discussed later.

Upon confirming the order by the customer, SOOP submits the order to the business where it will show up in a box on a tablet or other display device at the business as described above. SOOP also sends a message to the customer indicating that the order has been submitted, and that he or she should wait for it to be accepted.

### Alexa/Google Home Service:

Once the Alexa/Google service has connected SOOP as a skill, it will automatically tie itself to the SOOP user account. When Alexa is awakened, the user needs to tell it to connect to SOOP. Once this is done, Alex a/Google indicates it is ready and will listen for the order. The order can be dictated the same way as above.

Alexa/Google then dictates a confirmation and the SOOP app stores the history of the transaction. This simulates an actual phone call to the business for purposes of placing the order.

### Example (Alexa)

Consumer: “Alexa connect to SOOP”
Alexa: “Connected to SOOP, ready for your order”

### Consumer:

“Order from Joe's Pizza

1 eggplant parm hero

1 large pie with pepperoni

1 liter Coca-Cola

For Pickup”

### Alexa:

“Ok Richard! Here is what I am ordering to go from Joe's Pizza in New City, N.Y.:

1 eggplant Parmesan hero $7.99

1 large pizza pie $16.99
add Pepperoni $1.50

1 liter Coca-Cola $1.99

### Consumer: “No”

### Alexa:

“Please tell me what you would like to change?”

Consumer: “Add 1 eggplant parm hero
Change 1 liter Coca-Cola to 1 liter Sprite”
   Alexa: “Ok, here is what I am ordering to go from Joe's Pizza in New City N.Y.:

2 eggplant Parmesan hero $15.98

1 large pizza pie $16.99
add Pepperoni $1.50

1 liter Sprite $1.29

Tax: $2.99

Total: $38.75

Is this correct?”

### Consumer:

“Yes”

### Alexa:

“Order 12314 submitted to Joe's Pizza”

As mentioned, the business receives orders in queue format on their tablet, and can choose to accept or decline an order. If accepted (done by touching the order box and pressing accept), a confirmation is sent back to the consumer app (and a push notification, if allowed by the user, will be displayed as a text message). The acceptance triggers a message back to the consumer that the order has been accepted. It also indicates the length of time the order will take to be ready. If the customer wishes to cancel for any reason, they can send a message to SOOP to cancel the order via the app or via text, Alexa/Google Home, or any method compatible with the SOOP service.

The cancel request is indicated by typing or dictating (to the SOOP service contact record) “Cancel 1214”—where 1214 represents the order number. If an order is canceled before acceptance, the order box on the business app will be archived as a “Canceled by User” order and disappear from the Active Order's queue. If the order has already been accepted and marked as “In Process,” the business app will display the original order in red indicating to cancel with a clear display of “CANCEL”. This informs the business operator that the accepted order has been canceled and w ill give them the opportunity to accept or decline the cancellation request. If an order is declined, the order is sent back to the user as “declined,” with any reason specified by the business. The user can then resubmit the order with any necessary changes.

### Additional SOOP Features

### Asking For Menu:

SOOP can allow a user to ask for a menu from the business by specifying the business's name, and the word Menu. For example: “Joe's Pizza Menu”. SOOP then sends the user a PDF or a web URL for retrieving the business's menu.

### Guide Me:

If a user is not sure how to write up an order properly, SOOP can guide them through the process in response to the command “Guide Me”. SOOP will ask for three variables, viz., Business, Items, and Pickup/Delivery, in an easy to understand question format. It first asks for the business, then the items in, e.g., list format wherein each item is separated by a carriage return, and then whether the order is for pickup or delivery.

### Ask For Help:

At any time, a user can text “Help” to SOOP, and SOOP will respond with context sensitive help by providing a URL with the information needed.

### Businesses Nearby:

A user can ask for a list of businesses nearby. When SOOP receives the request, it asks what category of business the user is in the mood for, e.g., Sushi, Chinese, etc. Once the user responds, SOOP invokes a web URL that checks the user's location via a Location Service, and then filters businesses in a specified radius that match the category indicated. This gives the user an accurate list of businesses from which to choose and then order.

### Finding Business by Food Search:

As mentioned above, SOOP allows the business to enter or upload a database of menu items. Each menu item allows for the addition of keywords to make it more forgiving when a customer types in a menu item that is not spelled quite the same as it is spelled on the actual menu. This allows a customer to find a business (or list of businesses) by searching for menu items. For example, if a customer sends SOOP a text saying “Tacos,” SOOP will respond with a list of businesses within the customer's specified radius that serves Tacos.

### Color Coding System and Notifications:

On the business order queuing side, the orders appear in boxes on a tablet or web screen. Each box is preferably color coded to indicate either a new or a stale order. When an order first comes in, a counter is displayed showing how long the order has been waiting in queue. A green border is placed around each new order box.

After determined time intervals, the green border around a given new order box will turn yellow, and then red if the order has not been accepted by the business operator. Once the box turns red, notifications start to be sent to the customer indicating that the business has not yet responded, and that SOOP is acting on it. After another time interval, the customer and the business manager receive notifications that the order still has not been accepted. After, e.g., 15 minutes, the order is auto-canceled.

The user may also have the ability to cancel his or her order any time throughout the process. If auto-canceled, SOOP archives the order and indicates the time stamp and reason, e.g., Auto-Canceled due to no response. Once the order is accepted or rejected, the order is archived with the appropriate response, e.g., accepted, rejected, canceled by user, or auto-canceled, and SOOP keeps track of the time it took to respond along with the color status of the order box at the tine of the response. This information is used for the order history and reports discussed later.

### Hours of Operation:

SOOP allows the business to choose its hours of operation. This is displayed in schedule form in the location preferences of the businesses. A business operator can choose standard hours for all days of the week. If an order is submitted to that location after operating hours, a message is returned indicating that the business is currently closed.

### Holiday Hours:

A business can pre-program its holiday hours by date. It can add a Holiday by specifying a date, add a label for the holiday, and choose whether it is closed the entire day, or specify custom open hours for that day. If a customer sends an order to the business on a holiday, they will receive an automated message indicating that the business is currently closed for that holiday, using the label provided for the holiday name.

### Payments:

SOOP has integration with a payments system wherein a customer and a business can set up their account. As part of the registration process, a customer has the ability to attach a credit card, debit card, or back account info to their account. The business provides their bank account info during the registration process. During a transaction (an order sent to the business), the business operator indicates the total price for the order as part of their acceptance of the order. When the customer receives the acceptance and the price for the order, SOOP initiates a payment request on behalf of the business. SOOP then knows the business's account info as well as the customer's (using tokenization). Upon payment acceptance by the customer, the customer's payments account will be charged and the money will be transferred to the business's account. This payment engine can be handled by a payments company.

### Favorite Business:

A user can specify a favorite business. He or she can log into their account using the web portal or app, search for a business in a user definable radius, and add the business as a favorite. When adding the business, the user can enter a label that represents the business. When the user places an order and uses the label, SOOP recognizes that the order is to be sent to and will order from the user's favorite business.

For example, a user can add Joe's Pizzeria and Ristorante in New City, N.Y. as a favorite, using the label “Joe's.” If the user sends an order to SOOP and indicates the business as “Joe's,” then SOOP confirms the order as Joe's Pizzeria and Ristorante in New City, N.Y. and consequently sends the order to the correct business. This is intended to make it easier to place an order with a business that the customer frequents.

### Favorite Order:

Any order can be saved as a favorite for the customer. The customer can define a favorite order by, e.g., typing “Favorite,” followed by an order number (Favorite 1234). SOOP then asks for a label for that order so the customer can easily remember it the next time they place an order. The business/location and items will be stored in that favorite record. The method of delivery (pickup or delivery) need not be stored.

For example, if an order (order 1234) is placed at Joe's Pizzeria and Ristorante, the customer can type “Favorite 1234”. SOOP will ask for the label. The customer may respond: “Joe's Usual”. The next time the customer wants to place the same order, they can simply send a message “Joe's Usual.” SOOP will then ask if the order is pickup or delivery, confirm, and then submit the order as normal to the correct business.

### Reports:

All order history is archived and available for reporting. The SOOP engine is comprised of a database server that has consumer contact information and preferences as well as business information and preferences. The business can retrieve order information from consumers as well as consumer statistics (frequency of orders, delivery vs to go, most frequent items ordered, etc.). Consumers can view history and statistics in a similar manner. Reports can be displayed via a user dashboard as well as a reporting screen with filtered lists reports. All reports are pulled from data stored from each message transaction and order transaction. There may be reports including but not limited to, Orders by Response Time, Average Response Time, Activity Streams, Orders by Hours of the Day, Active Orders, Number of Businesses, Number of Locations, Order Status Report, Order History (filtered by date, customer, response time, color status, business, and location).

### Marketing Features:

As a business accumulates order information from customers along with reportable data, additional marketing tools can be added to encourage return business further. The SOOP engine can push notifications to consumers as well as rewards (badges, coupons, etc.). This can tie nicely into third party loyalty systems in the future. Through the business app/web portal, a business can send messages to their customers who have placed orders with them, and who have opted in to receiving unsolicited communications.

### Reservation System:

SOOP can provide a method of communicating orders to businesses. The same method of communication allows a customer to specify a business, date of required reservation, and number of guests. The customer simply specifies that it is a reservation as well as the business name, and the details of the reservation. On the business app/web portal, the reservation is separated from orders by displaying in a separate Reservations tab. The business operator can respond to the reservation similarly to the orders as mentioned previously. They may either accept it or reject it. With a rejection, however, the business operator may still be allowed to suggest other time slots from which the customer can choose, or cancel.

### Aggregated Data and Advertising Features:

Buying habits and line item data can be stored in the SOOP database for aggregate statistics. This can be an additional income source from companies that are seeking mass consumer statistics. Anonymous data can be accumulated and used. Additionally, the data can be used to target certain customers based on buying habits. SOOP can have a database of customers (including contact information), including which businesses the customers patronize and what items they purchase. The data can be used in conjunction with the marketing features mentioned above to offer advertising services to various companies. A privacy policy will limit advertisements only to those who opt in.

### Advertising Customer Portal:

SOOP may have a separate portal for an advertiser, viz., a customer who wishes to send advertisements, or to upsell to customers of participating businesses. The portal can filter by, and not be limited to, business/location, category of business (Sushi, American, Chinese, etc.), menu items, country, city, state, zip (or equivalent), as well as customers by country, city, state, zip, menu item, and business/locations. The results will allow the business to market via the following:
a. Push Advertising: SOOP can work with a Digital Signage engine that displays revolving advertisement pictures. The Digital Signage Engine can include a web portal that a computing device will display on its screen. The screen can simply be a tablet that is logged into the Digital Signage Web Portal. Each login can be unique to each participating SOOP business and will display ads that are deposited there. The advertiser can use the filters, mentioned above, to choose which participating businesses will receive their ads.
b. Upsell Advertising: The Advertiser can create upsells in the form of suggestions to participating businesses. These upsells can be automatically sent to the customers when they are placing an order with SOOP. For example, if Coca Cola wishes to advertise, then when a customer places an order with SOOP and does not specify drinks, a message can be sent to the customer during the ordering process that says “Would you like to add a 2 liter Coca Cola bottle to your order? (Yes or No)”
c. Banner Ads to the Businesses: Advertisers may utilize some space on the tablet screen of the business to send advertisements that are meant for the business itself. Each advertisement is a “Pay-Per-Click” ad where the business can click (or touch) the ad to have information emailed to them. Touching the ad will not exit the screen they are on. It will simply allow the advertisement to be em ailed to the email address on file in the business's SOOP account.

While the foregoing represents preferred embodiments of the present invention, it will be understood by persons skilled in the art that various changes, modifications, and additions can be made without departing from the spirit and scope of the invention, and that the invention includes all such changes, modifications, and additions that are within the scope of the following claims.

1. A method of placing orders by a consumer online for food items to a desired business, comprising:
providing one or more messaging servers;
receiving, by a messaging server, an order message from the consumer identifying the consumer, the desired business, and one or more food items for delivery to or for pick-up by the consumer;
sending, from the messaging server, a response to the order message requesting the consumer to confirm the order message as received by the messaging server;
upon receiving a confirmation of the order message from the consumer, sending, from the messaging server, the order message to the desired business;
providing a display device at the location of the business; and
displaying, on the display device at the business, the order message as sent to the business from the messaging server.

2. A method of placing orders for food items according to claim 1, including sending an acceptance message from the business to the messaging server to indicate that the business accepts the order message, and to request a corresponding payment from the consumer.

3. A method of placing orders for food items according to claim 2, including sending, from the messaging server, a notification to the consumer that the business accepted the order message and requested the corresponding payment from the consumer.

4. A method of placing orders for food items according to claim 3, including providing, in the notification to the consumer, a request that the consumer either accept the payment requested by the business, or enter a change to the previous order message.

5. A method of placing orders for food items according to claim 1, including providing a database server configured for storing consumer contact information and corresponding preferences including form of payments, and business information and corresponding preferences.

6. A method of placing orders for food items according to claim 5, including configuring the database server to enable businesses to retrieve consumer order information and statistics including one or more of (a) frequency of orders, (b) whether for delivery or pick-up, and (c) most frequently ordered items.

7. A method of placing orders for food items according to claim 5, including configuring the database server to store data corresponding to all consumer orders, and to produce corresponding reports including one or more of (I) orders by response time, (ii) average response time, (iii) activity streams, (iv) orders by hours of the day, (v) active orders, (vi) number of businesses, (vii) number of locations, (viii) order status, and (ix) order history.

8. A method of placing orders for food items according to claim 7, including filtering the reports produced by the database server by one or more of date, customer, response time, business, and location.

9. A method of placing orders for food items according to claim 1, including providing a tablet as the display device at the business.

10. A method of placing orders for food items according to claim 1, including providing a web portal for enabling the consumer or the desired business to connect with the messaging servers.

11. A method of placing orders for food items according to claim 1, including providing an artificial intelligence (AI) engine for recognizing certain key words input by the consumer and for facilitating placement of the orders.

12. An online ordering platform for enabling a consumer to place orders online for food items to a desired business, comprising:
one or more messaging servers configured for receiving an order message from the consumer identifying (a) the consumer, (b) the desired business, and (c) one or more food items for delivery to or for pick-up by the consumer;
wherein, responsive to the order message, the messaging servers are operative to send a response to the order message requesting the consumer to confirm the order message as received by the messaging servers;
upon receiving a confirmation of the order message from the consumer, the messaging servers are operative to send the order message to the desired business; and
a display device at the location of the business, wherein the display device is operative to display the order message as sent to the business from the messaging servers.

13. An online ordering platform according to claim 12, wherein the messaging servers are configured to receive an acceptance message that is sent from the business to indicate that the business accepts the order message, and to request a corresponding payment from the consumer.

14. An online ordering platform according to claim 13, wherein the messaging servers are configured to send a notification to the consumer that the business accepted the order message and requested the corresponding payment from the consumer.

15. An online ordering platform according to claim 14, wherein the notification to the consumer includes a request that the consumer either accept the payment requested by the business, or enter a change to the previous order message.

16. An online ordering platform according to claim 12, including a database server configured for storing consumer contact information and corresponding preferences including form of payments, and business information and corresponding preferences.

17. An online ordering platform according to claim 16, wherein the database server is configured to enable businesses to retrieve consumer order information and statistics including one or more of (a) frequency of orders, (b) whether for delivery or pick-up, and (c) most frequently ordered items.

18. An online ordering platform according to claim 16, wherein the database server is configured to store data corresponding to all consumer orders, and to produce corresponding reports including one or more of (i) orders by response time, (ii) average response time, (iii) activity streams, (iv) orders by hours of the day, (v) active orders, (vi) number of businesses, (vii) number of locations, (viii) order status, and (ix) order history.

19. An online ordering platform according to claim 18, wherein the reports produced by the database server are filtered by one or more of date, customer, response time, business, and location.

20. An online ordering platform according to claim 12, wherein the display device at the business is in the form of a tablet.

21. An online ordering platform according to claim 12, including a web portal configured to enable the consumer or the desired business to connect with the messaging servers.

22. An online ordering platform according to claim 11, including an artificial intelligence (AI) engine configured to recognize certain key words input by the consumer in order to facilitate placement of the orders.
